(19) United States
(12) Patent Application Publication
(10) Pub. No.: US 2025/0001414 A1
(43) Pub. Date: Jan. 2, 2025

(54) DROPLET GENERATION CHIP INCLUDING ELECTRODE WITH VARIABLE SENSING AREA

(71) Applicant: INJE UNIVERSITY INDUSTRY-ACADEMIC COOPERATION FOUNDATION, Gimhae-si Gyeongsangnam-do (KR)

(72) Inventors: Ki-Ho HAN, Busan (KR); Jae Wook RYU, Busan (KR)

(73) Assignee: INJE UNIVERSITY INDUSTRY-ACADEMIC COOPERATION FOUNDATION, Gimhae-si Gyeongsangnam-do (KR)

(21) Appl. No.: 18/700,579

(22) PCT Filed: Oct. 12, 2022
(86) PCT No.: PCT/KR2022/015325

§ 371 Date: Apr. 11, 2024

(30) Foreign Application Priority Data
Oct. 12, 2021 (KR) 10-2021-0134719

(51) Int. Cl. B01L 3/00

(52) U.S. Cl. CPC B01L 3/502715; B01L 3/502784; B01L 2200/0647; B01L 2300/0645; B01L 2400/0487

(57) ABSTRACT

Provided is a droplet generation chip including an electrode with a variable sensing area, including a disposable panel in which a microfluidic channel is formed; a substrate which is separated from the disposable panel and can be reused; a thin film which separates the disposable panel and the substrate from each other; a negative pressure generation means so as to allow the disposable panel and the substrate to be attached to or detached from each other; and a sensing electrode unit measuring the length of a droplet in a sample passing through the microfluidic channel, the sensing electrode unit including a first application electrode and a second application electrode; a control means for individual on/off control of application signals of the first application electrode and the second application electrode; and a sensing electrode for sensing a signal according to the position of the droplet introduced into the microfluidic channel.

### TECHNICAL FIELD

The present disclosure relates to a droplet generation chip including an electrode with a variable sensing area, and more specifically, to a droplet generation chip including an electrode with a variable sensing area that is capable of changing a droplet size-sensing area of an electrode by the individual ON/OFF control of application signals of application electrodes, so as to measure various droplet sizes.

### BACKGROUND ART

Recently, morphological characteristics of droplets, such as length and speed, have been measured in real time and applied to researches on drug delivery, cell research, material synthesis, chemical reaction, etc.

However, in the related art, as a droplet material changes, the conductivity of a droplet also changes, and a sensing voltage value varies depending on the conductivity. For a material with a different conductivity, there was a disadvantage in that it was difficult to measure the length of a droplet using only the measured voltage value. Thus, the applicant of the present disclosure proposed a method for measuring the length of a droplet using a capacitive electrode, which can measure the length of the droplet even for a material with a different conductivity as long as the dielectric constant of the droplet is the same.

However, there are cases where a gap between droplets is shorter than an electrode length when creating droplets of a certain size (e.g., 250 um), due to limitation in a microfluidic channel structure. In this case, the droplets overlap one another on the electrode, and in order to increase the gap, an oil flow rate needs to be increased, but this causes the size of the droplets to be decreased, making it impossible to achieve a desired size.

On the other hand, if the flow rate of a sample is slowed, the gap between droplets can be widened but the problem of reducing the throughput of droplet generation arises.

Meanwhile, there was also a problem in that if the size of the droplet was reduced, the amount of oil filled between the droplets had to increase. For example, the size of the droplet could be adjusted to be small, but more oil was needed as the droplet size was reduced. Also, when a certain amount of samples had to be used, the gap had to be maintained for sensing as the length of the droplet was reduced. This caused a problem in that a lot of expensive oil was used. Therefore, the applicant of the present disclosure desires to propose a solution to the problems through repetitive researches on those problems.

### DISCLOSURE

### Technical Problem

The present disclosure was derived to solve those problems of the related art, and is directed to provide a droplet generation chip including an electrode with a variable sensing area that is capable of changing the length of a droplet size-sensing area of an electrode by the individual ON/OFF control of application signals of application electrodes, when the size of the droplet is measured with a capacitive electrode.

The present disclosure is also directed to provide a droplet generation chip including an electrode with a variable sensing area that is capable of preventing droplets from overlapping one another on an electrode due to a gap between droplets being shorter than an electrode length.

The present disclosure is further directed to provide a droplet generation chip that is capable of varying an electrode length to be longer than a droplet length and shorter than a gap between droplets by adjusting the electrode length, other than changing a sample and an oil flow rate, in order to adjust the size of the droplets and a droplet generation throughput.

The present disclosure is further directed to provide a droplet generation chip including an electrode with a variable sensing area that is capable of varying the length of a sensing area of an electrode depending on the size of a droplet and reducing a gap between the droplets when the droplets are small, so as to decrease an amount of oil used, thereby enabling economical droplet generation.

### Technical Solution

In order to achieve the above aspects, the present disclosure provides a droplet generation chip including an electrode with a variable sensing area, the chip including a disposable panel on which a microfluidic channel is formed, a substrate that is separated from the disposable panel to be reusable, a thin film that separates the disposable panel and the substrate from each other, a negative pressure generation means that applies negative pressure between the disposable panel and the substrate so that the disposable panel and the substrate are attached to or detached from each other, and a sensing electrode unit that is patterned on the substrate or the thin film to measure a length of a droplet in a sample passing through the microfluidic channel, in which the sensing electrode unit includes a first application electrode that is disposed in a flow direction of the sample passing through the microfluidic channel, a second application electrode that is symmetrically disposed parallel to the first application electrode, a control means that performs an individual ON/OFF control of application signals of the first application electrode and the second application electrode, and a sensing electrode that senses a signal according to a position of a droplet introduced into the microfluidic channel.

In the present disclosure, the first application electrode and the second application electrode may be provided in plurality, respectively, disposed separately, and the first application electrode and the second application electrode symmetrically disposed to each other may form a pair to receive an ON/OFF application signal.

The control means may include voltage application lines that are connected to the first application electrode and the second application electrode, respectively, switches that are disposed on the voltage application lines, respectively, control lines that are connected to control the respective switches to be on or off by transmitting control signals to the switches, and a controller that controls the switches to be on or off to vary a length of the sensing area of each of the first application electrode and the second application electrode.

Here, the controller may selectively transmit a control signal to prevent droplets from overlapping each other in the sensing area of the sensing electrode by reducing the length of the sensing area of the electrode when the droplets are small and increasing the length of the sensing area of the electrode when the droplets are large.

In this case, the controller may transmit the control signals to the switches of the pair of the first application electrode and the second application electrode that are symmetrical to each other, and selectively vary the length of the sensing area by transmitting the control signals, starting from the first application electrode and the second application electrode disposed at a central portion.

Additionally, a sensing signal line may be connected to a sensing electrode of the sensing electrode unit, an amplifier that amplifies a sensing signal may be connected to the sensing signal line, and the amplified sensing signal may be output through the amplifier.

### Advantageous Effects

According to the present disclosure as described above, there is an advantage in that the length of a droplet size-sensing area of an electrode can be varied by the individual ON/OFF control of application signals of application electrodes. This can prevent droplets from overlapping each other in the sensing area of a sensing electrode by reducing the length of the sensing area of the electrode when the droplets are small and increasing the length of the sensing area of the electrode when the droplets are large.

Also, the length of a sensing area of an electrode can be varied depending on the size of a droplet and a gap between droplets when the droplets are small can be reduced, which can result in decreasing an amount of oil used so as to suppress waste of oil, thereby enabling economical droplet generation.

In this way, droplets can be generated at an economical cost, so it can be used in various fields through various applications.

### DESCRIPTION OF DRAWINGS

FIG. 1 is an exploded perspective view illustrating the overall configuration of a droplet generation chip including an electrode with a variable sensing area according to the present disclosure.

FIG. 2 is a coupled perspective view of FIG. 1.

FIG. 3 is a diagram illustrating the configuration of a sensing electrode unit according to the present disclosure.

FIG. 4 is a plan view illustrating an exemplary embodiment of the length of a sensing area in the sensing electrode unit according to the present disclosure.

FIG. 5 is a diagram illustrating exemplary embodiments of a droplet gap according to a droplet size in the droplet generation chip according to the present disclosure.

FIG. 6 is a graph showing the changes in sensing voltages according to droplet size/gap and sensing area length in an exemplary embodiment of the present disclosure.

FIG. 7 is a table showing a sensing area length with the highest sensitivity for each droplet size/gap, in an exemplary embodiment of the present disclosure.

### MODES OF THE INVENTION

Hereinafter, a preferred exemplary embodiment of the present disclosure will be described in detail with reference to the attached drawings. However, the present disclosure is not limited to the exemplary embodiment disclosed below and will be implemented in various different forms, but the exemplary embodiment of the present disclosure only serves to ensure that the disclosure of the present disclosure is complete and helps those skilled in the art to fully understand the scope of the disclosure.

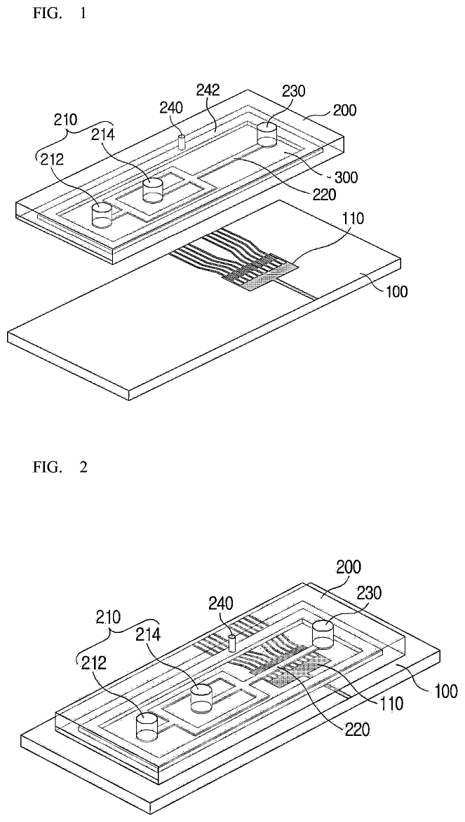

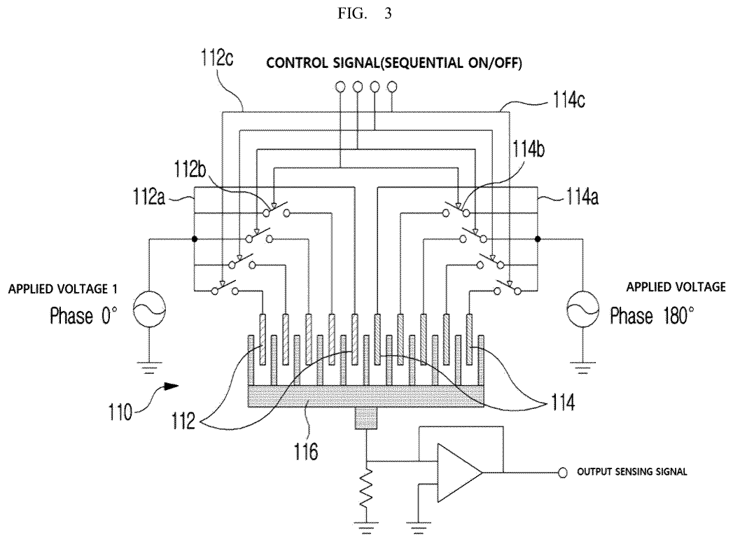

FIG. 1 is an exploded perspective view illustrating the overall configuration of a droplet generation chip including an electrode with a variable sensing area according to the present disclosure, FIG. 2 is a coupled perspective view of FIG. 1, and FIG. 3 is a diagram illustrating the configuration of a sensing electrode unit according to the present disclosure.

The droplet generation chip having an electrode with a variable sensing area according to the present disclosure generally includes a disposable panel 200 in which a microfluidic channel 220 is formed, a substrate 100 that is separated from the disposable panel 200 and is reusable, a thin film 300 that separates the disposable panel 200 and the substrate 100 from each other, a negative pressure generation means 240, 242 that enables the disposable panel 200 and the substrate 100 to be attached to and detached from each other, and a sensing electrode unit 110 that is patterned on the substrate 100 or the thin film 300 to measure the length of droplets in a sample passing through the microfluidic channel 220.

The disposable panel 200 may be made of a PDMS material, and may include a plurality of injection ports 210 through which fluids with different dielectric constants flow in, respectively, a microfluidic channel 220 through which the fluids injected through the injection ports pass, and a discharge port 230 through which the fluids passing through the microfluidic channel is discharged.

In the present disclosure, the injection port 210 is provided in plurality so that fluids with different dielectric constants may be respectively injected. In the exemplary embodiment of the present disclosure, the plurality of injection ports includes an oil injection port 212 through which oil with a low dielectric constant is injected, and a sample injection port 214 through which a sample with a higher dielectric constant than oil is injected.

A sample (PBS) flows along a channel which is formed linearly from the sample injection port 214 to the discharge port 230, and oil flows along a channel which is formed from the oil injection port 212 to vertically join the channel, through which the sample flows.

The microfluidic channel 220 is formed on the lower surface of the disposable panel 200, and the thin film 300 is attached to the lower surface of the disposable panel 200 to measure a voltage value at the electrode of the substrate 100 while preventing the sample flowing through the microfluidic channel 220 from being in direct contact with the electrode of the substrate 100.

Here, the thin film 300 must be made to have a size that includes the entire microfluidic channel 220, and is preferably made to be thin, for example, to be about 4 μm, so that electric fields, magnetic forces, etc. may be well transmitted to the sample flowing in the microfluidic channel 220.

In the present disclosure, the disposable panel 200 in which the microfluidic channel 220 is disposed and the substrate 100 on which the electrode is disposed are separately constructed, thereby preventing direct contact between a fluid and the electrode and making it possible to reuse the electrode for measurement.

Meanwhile, the sensing electrode unit 110 is patterned on the substrate 100 or the thin film 300 and measures the length of a droplet using a voltage value measured by the capacitance value of a fluid passing through the microfluidic channel.

In the exemplary embodiment of the present disclosure, the sensing electrode unit 110 is shown to be formed on the upper surface of the substrate 100, but the sensing electrode unit 110 may also be formed on the lower surface of the thin film 300.

In the present disclosure, when droplets pass through the sensing electrode unit 110, the voltage value measured at the electrode becomes higher as the length of the droplets is longer. Therefore, the length of the droplets is measured according to a principle of measuring the length of the droplets using the voltage value measured at the sensing electrode unit 110.

In other words, an electric field is normally formed in the channel, but when oil flows, the current is not measured due to the low dielectric constant of the oil. Then, the current flows in the channel when a sample flows. The current is sensed by the sensing electrode unit to measure the length of the droplet.

Meanwhile, the sensing electrode unit 110 includes a first application electrode 112 formed in the flow direction of a sample passing through the microfluidic channel, a second application electrode symmetrically disposed parallel to the first application electrode 112, a control means to perform an individual ON/OFF control for application signals of the first application electrode 112 and the second application electrode 114, and a sensing electrode 116 to sense signals according to the position of a droplet introduced into the microfluidic channel.

In the present disclosure, as illustrated in FIG. 3, the first application electrode 112 and the second application electrode 114 are separately provided in plurality, respectively, and the first application electrode 112 and the second application electrode 114 that are symmetrical to each other form a pair to receive an ON/OFF application signal.

That is, the first and second application electrodes 112 and 114 may selectively vary the length of a sensing area through an individual control signal.

Here, the control means may include voltage application lines 112a and 114a connected to the first application electrode 112 and the second application electrode 114, respectively, switches 112b and 114b disposed on the voltage application lines, respectively, control lines 112c and 114c connected to transmit control signals to the switches, respectively, for ON/OFF control, and a controller (not illustrated) to control ON/OFF of the switches to change the lengths of sensing areas of the first application electrode and the second application electrode.

The controller may selectively transmit a control signal to prevent droplets from overlapping each other in the sensing area of a sensing electrode by reducing the length of the sensing area of the electrode when droplets are small and increasing the length of the sensing area of the electrode when droplets are large.

In this case, the controller transmits control signals to the switches of the symmetrical pair of first and second application electrodes 112 and 114. As illustrated in FIG. 3, the controller transmits control signals (control signals A, B, C, and D), starting from the first and second application electrodes located at a central portion, to sequentially control those switches to be ON/OFF, thereby selectively varying the length of the sensing area.

That is, while the first application electrode and the second application electrode disposed at the central portion of the sensing electrode 116 in its longitudinal direction are in an ON state, the controller transmits control signals to other application electrodes, starting from a first application electrode and a second application electrode located next to the central first and second application electrodes. Accordingly, the control signals A, B, C, and D may be sequentially applied to turn on the switches connected to the control lines 112c and 114c.

In this way, by sequentially applying control signals through the control lines, the switches 112b and 114b disposed on the respective voltage application lines may be controlled to be turned on/off, and the ON/OFF control for the switches 112b and 114b may allow the length of the sensing area to be selectively varied.

A sensing signal line may be connected to the sensing electrode 116 of the sensing electrode unit 110, and an amplifier that amplifies a sensing signal may be connected to the sensing signal line. Thus, the amplified sensing signal may be output through the amplifier.

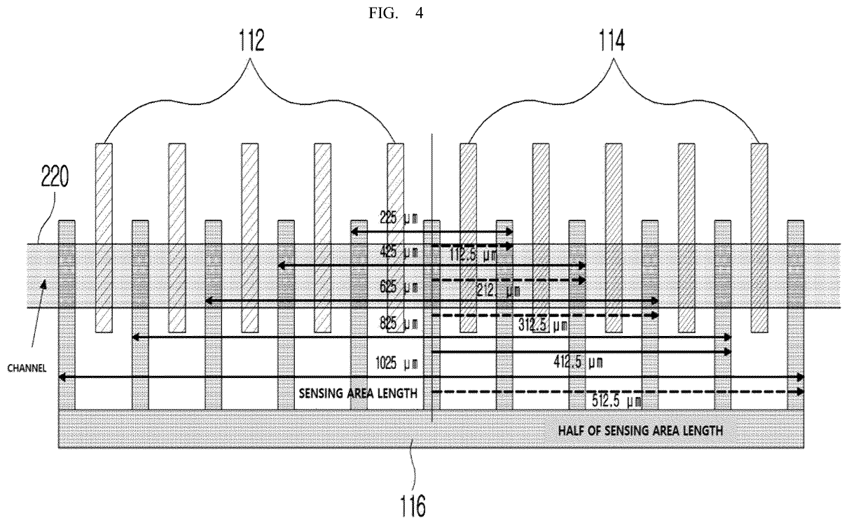

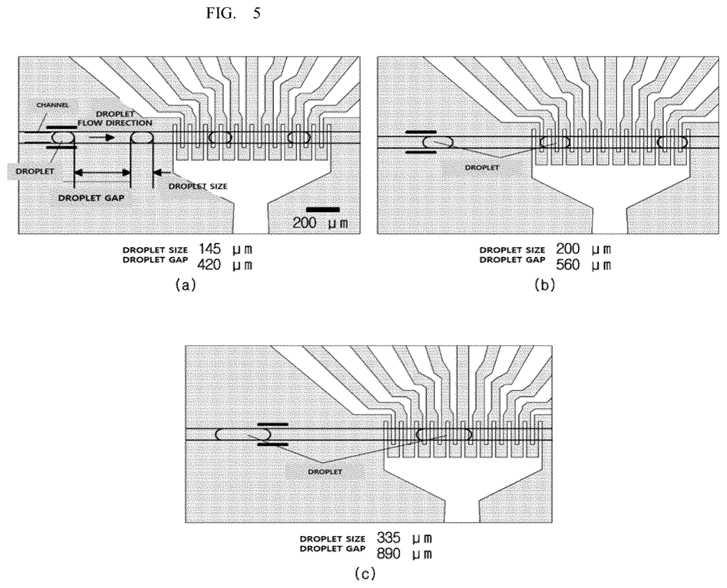

As illustrated in FIG. 4, the first application electrode 112 and the second application electrode 114 are symmetrically disposed in parallel, and the sensing electrode 116 for sensing a signal is disposed on the opposite side.

The length of droplets that can be measured by the sensing electrode unit 110 ranges from the width length of the channel to the length of the first application electrode 112. The shortest measurable length of a droplet is the same as the width of the channel, and the longest length of a droplet is up to the length of the first application electrode.

In an exemplary embodiment of the present disclosure, the first application electrode 112 is 512.5 μm long, and has an entire sensing area which is 1025 μm long, so the length of droplets up to 512.5 μm may be measured.

However, since the width of the channel and the length of the first application electrode 112 may be applied in various ways depending on exemplary embodiments, the present disclosure is not limited thereto.

As such, in the present disclosure, the length of a sensing area of an electrode may vary depending on the size of a droplet and a gap between droplets when the droplets are small may be reduced. This may result in decreasing an amount of oil used, thereby enabling economical droplet generation.

FIG. 5 is a diagram illustrating exemplary embodiments of a droplet gap according to a droplet size, in the droplet generation chip according to the present disclosure. (a) shows an example in which a droplet size is 145 μm and a droplet gap is 420 μm, (b) shows an example in which a droplet size is 200 μm and a droplet gap is 560 μm, and (c) shows an example in which a droplet size is 335 μm and a droplet gap is 890 μm.

In this way, since the droplet gap may be reduced when the droplet size is small, an amount of oil filled between the droplets may be reduced.

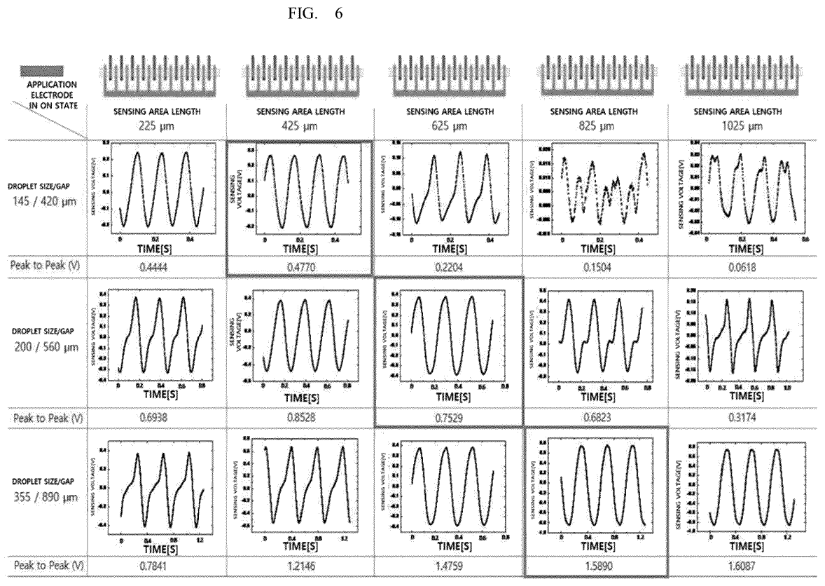

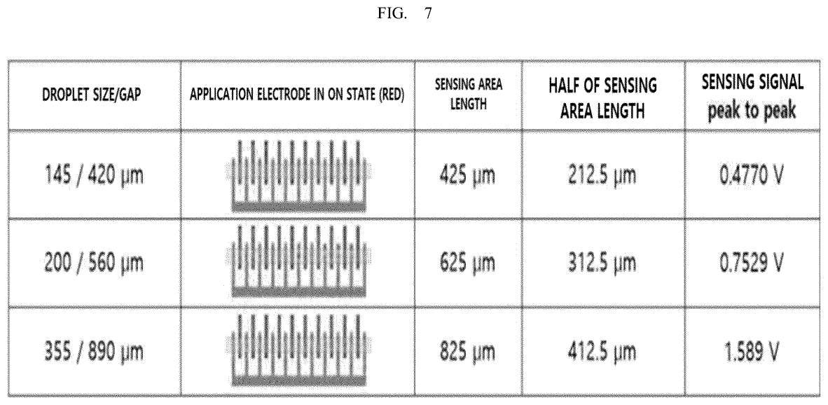

FIG. 6 is a graph showing the changes in sensing voltages according to droplet size/gap and sensing area length in an exemplary embodiment of the present disclosure, and FIG. 7 is a table showing a sensing area length with the highest sensitivity for each droplet size/gap, in an exemplary embodiment of the present disclosure.

To show the necessity of an electrode with a variable sensing area, a sensing signal was measured according to the length of a sensing area in which various sizes of droplets are measurable. It can be seen that a sensing signal measured by the length of the sensing area varies depending on the droplet size and droplet gap.

Since half the length of the sensing area is the maximum droplet size that can be measured, accurate measurement is not possible when the size of the droplet is longer than half the length of the sensing area. In this case, the sensing area of the electrode is increased.

Additionally, when the droplet gap is shorter than the length of the sensing area, the droplets overlap in the sensing area, making accurate measurement of the droplet size impossible. However, in this case, the length of the sensing area is reduced.

The length of each sensing area with the best sensitivity when measuring droplets with sizes of 140, 200, and 365 μm, respectively, is shown in the table shown in FIG. 7.

The present disclosure is not limited to the exemplary embodiment described above but is defined by the claims, and it is obvious that various changes and modifications can be made within the scope of the claims by those skilled in the art.

1. A droplet generation chip including an electrode with a variable sensing area, the droplet generation chip comprising:
a disposable panel in which a microfluidic channel is formed:
a substrate that is separated from the disposable panel to be reusable:
a thin film that separates the disposable panel and the substrate from each other:
a negative pressure generation means that applies negative pressure between the disposable panel and the substrate so that the disposable panel and the substrate are attached to or detached from each other; and
a sensing electrode unit that is patterned on the substrate or the thin film to measure a length of a droplet in a sample passing through the microfluidic channel,
wherein the sensing electrode unit includes a first application electrode that is disposed in a flow direction of the sample passing through the microfluidic channel, a second application electrode that is symmetrically disposed parallel to the first application electrode, a control means that performs an individual ON/OFF control of application signals of the first application electrode and the second application electrode, and a sensing electrode that senses a signal according to a position of the droplet introduced into the microfluidic channel.

2. The droplet generation chip of claim 1, wherein the first application electrode and the second application electrode are provided in plurality, respectively, disposed separately, and
the first application electrode and the second application electrode symmetrically disposed to each other form a pair to receive an ON/OFF application signal.

3. The droplet generation chip of claim 2, wherein the control means includes:
voltage application lines that are connected to the first application electrode and the second application electrode, respectively:
switches that are disposed on the voltage application lines, respectively:
control lines that are connected to control the respective switches to be on or off by transmitting control signals to the switches; and
a controller that controls the switches to be on or off to vary a length of the sensing area of each of the first application electrode and the second application electrode.

4. The droplet generation chip of claim 3, wherein the controller selectively transmits the control signal to prevent the droplets from overlapping each other in the sensing area of the sensing electrode by reducing the length of the sensing area of the electrode when the droplets are small and increasing the length of the sensing area of the electrode when the droplets are large.

5. The droplet generation chip of claim 4, wherein the controller transmits the control signals to the switches of the pair of the first application electrode and the second application electrode that are symmetrical to each other, and selectively varies the length of the sensing area by transmitting the control signals, starting from the first application electrode and the second application electrode disposed at a central portion

6. The droplet generation chip of claim 1, wherein a sensing signal line is connected to the sensing electrode of the sensing electrode unit,
an amplifier that amplifies a sensing signal is connected to the sensing signal line, and
the amplified sensing signal is output through the amplifier.
